(19) United States
(12) Patent Application Publication
(10) Pub. No.: US 2024/0018997 A1
(43) Pub. Date: Jan. 18, 2024

(54) ULTRA-QUIET WHEEL HUB ASSEMBLY

(71) Applicant: AKTIEBOLAGET SKF, Götenborg (SE)

(72) Inventors: Riccardo Nardicchia, Torino (TO) (IT); Marco Romaneto, Pianezza (IT)

(21) Appl. No.: 18/218,621

(22) Filed: Jul. 6, 2023

(30) Foreign Application Priority Data
Jul. 13, 2022 (IT) 102022000014698

(51) Int. Cl. F16C 19/18; B60B 27/00; F16C 33/62

(52) U.S. Cl. CPC F16C 19/183; B60B 27/0094; F16C 33/62; B60B 2380/92; B60B 2310/616; F16C 2326/02; F16C 2223/30

(57) ABSTRACT

A wheel hub assembly includes a wheel hub unit having a radially outer ring with a first metal surface, a radially inner ring with a third metal surface, and a plurality of rolling bodies interposed between the inner ring and the outer ring. The hub assembly includes a suspension pillar with a second metal surface butt coupled to the first metal surface of the radially outer ring, and a constant velocity joint having a fourth metal surface butt coupled to the third metal surface of the radially inner ring. A coating having a plurality of hard particles and made of an organic matrix or an inorganic matrix covers at least one of the first metal surface and the third metal surface.

### CROSS-REFERENCE TO RELATED APPLICATIONS

This application is based on and claims priority to Italian Patent Application No. 102022000014698 filed on Jul. 13, 2022, under 35 U.S.C. § 119, the disclosure of which is incorporated herein by reference in its entirety.

### FIELD

The present disclosure relates to wheel hub assemblies and wheel hub units.

### BACKGROUND

In wheel hub assemblies, micro-slipping may occur between coupled surfaces of elements of the wheel hub assembly that can cause noise and have a negative effect on the coupling between the coupled surfaces.

Such noise is more noticeable in electric vehicles than in vehicles with internal combustion engines on account of the greater amount of background noise generated by the internal combustion engine compared to the engine of the electric vehicle. As such, this noise can become a concern for users of electric vehicles, and may suggest a malfunction of the wheel hub assembly and its components, when no such malfunction exists.

### SUMMARY

A wheel hub assembly may include a wheel hub unit with a radially outer ring, a radially inner ring, and a plurality of rolling bodies interposed between the inner ring and the outer ring to enable the relative rotation thereof. The outer ring may be provided with a first metal coupling surface designed to be mounted in contact with a corresponding second metal surface of a suspension pillar. The inner ring may terminate on the same side as the first metal surface with a first axial end, on which a small inner ring may be coupled. Either axial end or small inner ring may be provided with a third coupling metal surface or front surface, respectively. In the case of the former, the third metal surface may be designed to be mounted with a corresponding fourth metal surface of a constant velocity joint. In the case of the latter, the metal surface of the small inner ring may be mounted with a surface of an axial shoulder of the inner ring facing the small inner ring.

At least one of the first and third metal surfaces, the axial shoulder, and the front face of the small inner ring facing the axial shoulder of the inner ring may be covered with a protective layer or coating, which may be formed by an organic matrix, for example a synthetic polymer or a mixture of synthetic polymers. In the case of the first and third metal surfaces, the coating may also be alternatively made of an inorganic matrix, such as a metal matrix, in which hard particles are uniformly dispersed. The hard particles may have a Mohs hardness equal to or greater than 9 and dimensions of between 15 μm and 60 μm. In the case of an inorganic matrix with hard particles, the hard particles may make up between 10% and 50% by weight of the total weight of the coating. The coating may have a thickness of between 20 μm and 100 μm when applied.

Where the coating is applied to the axial shoulder of the inner ring and/or the front face of the small inner ring, the matrix of the coating may consist of an anaerobic sealant paste in which the specified quantity of hard particles has been uniformly dispersed before the coating is applied to the axial shoulder of the inner ring or the front face of the small inner ring.

### BRIEF DESCRIPTION OF THE DRAWINGS

The disclosure is described below with reference to the attached drawings, which show non-limiting example embodiments of the disclosure, in which:

FIG. 1 shows a longitudinal cross section view of a wheel hub assembly according to exemplary embodiments of the present disclosure;

FIG. 2 shows a longitudinal cross section view of a wheel hub unit according to exemplary embodiments of the present disclosure;

FIG. 3 shows a longitudinal cross section view of a wheel hub unit according to exemplary embodiments of the present disclosure;

FIG. 4 illustrates a longitudinal cross section view of a vehicle wheel hub unit according to exemplary embodiments of the present disclosure;

FIG. 5a illustrates a longitudinal cross section of a vehicle wheel hub unit according to exemplary embodiments of the present disclosure;

FIG. 5b shows an enlarged view of the wheel hub assembly in FIG. 5a; and

FIG. 6 illustrates a flow chart of a method for reducing noise and stabilizing a wheel hub assembly according to exemplary embodiments of the present disclosure.

### DETAILED DESCRIPTION

In wheel hub assemblies, micro-slipping may occur between elements of a wheel hub assembly that are otherwise stably coupled to one another. Examples of coupled surfaces include, but are not limited to, a fastening flange of a radially outer ring of the wheel hub assembly connected by screws or bolts to a vehicle suspension pillar, an inner ring of the wheel hub assembly that receives a device wheel, or between a portion of a constant velocity joint and the inner ring by means of a splined coupling. Such localized micro-slipping, even when so small as to be undetectable, nonetheless causes audible noise. Such noise is particularly prevalent when the wheel hub assembly is subjected to intense localized stresses, such as during a turn or a motion reversal.

Such noise is often not noticed in conventional vehicles with internal combustion engines on account of the background noise generated by the engine. But this noise can be more noticeable for users of electric vehicles due to the reduced noise generated thereby, suggesting a malfunction of the wheel hub assembly even if no such malfunction exists.

Known solutions to reduce or eliminate such noise rely on inserting additional elements, such as shims, between coupled surfaces of the wheel hub assembly likely to experience localized micro-slipping. Known solutions utilize shims with a high coefficient of friction, such as those described in U.S. Pat. No. 8,038,353, or a low coefficient, such as those described in JP 2020051444, both of which are incorporated herein by reference.

However, introducing additional elements to the wheel hub assembly can be costly and can encumber the assembly, which is not always acceptable. Assembly of these additional elements can complicate the assembly process of the wheel hub assembly, and both the additional element and any coatings or anti-corrosion paint used to protect coupled metal surfaces of the wheel hub assembly may be subject to wear.

Therefore, an object of the present disclosure is to provide a wheel hub assembly and a related rolling bearing and wheel hub unit that are not subject to micro-slipping when in use to reduce noise experienced during external stress periods, such as when steering or during a toque reversal, while maintaining a coupling between coupled surfaces subject to such external stresses. An additional object is to produce a wheel hub assembly with such benefits that is simple and inexpensive to build and assemble.

Another object of the present disclosure is to provide a method for ensuring stability of a butt coupling between two metal elements, such as between two coupled surfaces or flanges in mutual contact, to ensure the coupling is substantially unaffected by micro-slipping occurring as a result of mechanical stresses applied to the coupled elements.

With reference to the figures, a wheel hub assembly 1 may include a wheel hub unit 2 that includes a mixed rolling bearing 3 having two rows of rolling bodies, e.g., balls, rollers, needle rollers, or the like.

In some embodiments, wheel hub assembly 1 may further include at least one of a constant velocity joint 4 and a suspension pillar 5. In the exemplary embodiments shown, wheel hub assembly 1 includes both a constant velocity joint and a suspension pillar, but a person of ordinary skill in the art will appreciate that either a constant velocity joint 4 or a suspension pillar 5, but not both, may be included in wheel hub assembly 1 without departing from the scope of this disclosure.

In some embodiments, wheel hub unit 2 may include a radially outer ring 6, a radially inner ring 7, and a plurality of rolling bodies 8. In some embodiments, rolling bodies 8 may form two adjacent rows of rolling bodies interposed between inner ring 7 and outer ring 6 to enable relative rotation thereof.

In some embodiments, outer ring 6, inner ring 7, and rolling bodies 8 may be part of rolling bearing 3. In some embodiments, outer ring 6 may include a flange 9 integral therewith and used to attach rolling bearing 3 to suspension pillar 5. In some embodiments, inner ring 7 may include a flange 10 integral therewith and used to attach rolling bearing 3 to a vehicle wheel (not illustrated for simplicity). In some embodiments, flange 10 may be located at a first axial end 11 of inner ring 7 axially opposite flange 9 of outer ring 6. In some embodiments, rolling bearing 3 may be a “third generation” bearing, meaning rolling bearing 3 forms the entire wheel hub unit 2.

However, in a more conventional solution, flanges 9 and/or 10 may be formed on a wheel hub or spindle provided with rolling bearing 3 without one or both of the flanges 9 and 10, but that includes outer and inner rings 6, 7 angularly connected to flanges 9 and 10, respectively.

In some embodiments, inner ring 7 may be split into two separate elements that are angularly and rigidly coupled together. A first element may be an annular element formed by axial ends 11 and 12 and flange 10, and a second element may be a small inner ring 13 driven onto axial end 12 to butt axially against an axial shoulder 14 of inner ring 7 facing towards axial end 12.

As a result, small inner ring 13 may be butt coupled with axial shoulder 14 of inner ring 7. In some embodiments, axial shoulder 14 may face away from axial end 11 and be in direct contact with a front face 15 of small inner ring 13 that faces axial shoulder 14 and axial end 11.

In some embodiments, outer ring 6 may include a first metal surface 16 butt coupled or able to be butt coupled with a corresponding second metal surface 18 of suspension pillar 5. In some embodiments, first metal surface 16 may be specifically defined by a front face of flange 9 facing away from flange 10.

In some embodiments, inner ring 7 may include a third metal surface 19 butt coupled or able to be butt coupled with a corresponding opposing fourth metal surface 20 of constant velocity joint 4. In some embodiments, fourth metal surface 20 may be on a bell of constant velocity joint 4, which may be regarded as a radially outermost element of constant velocity joint 4.

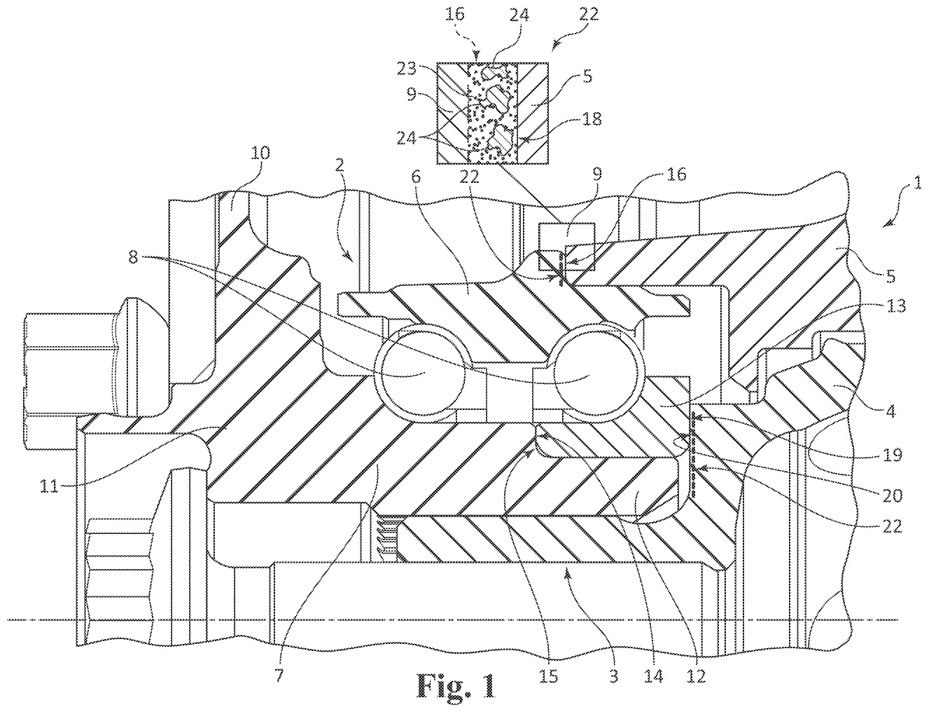

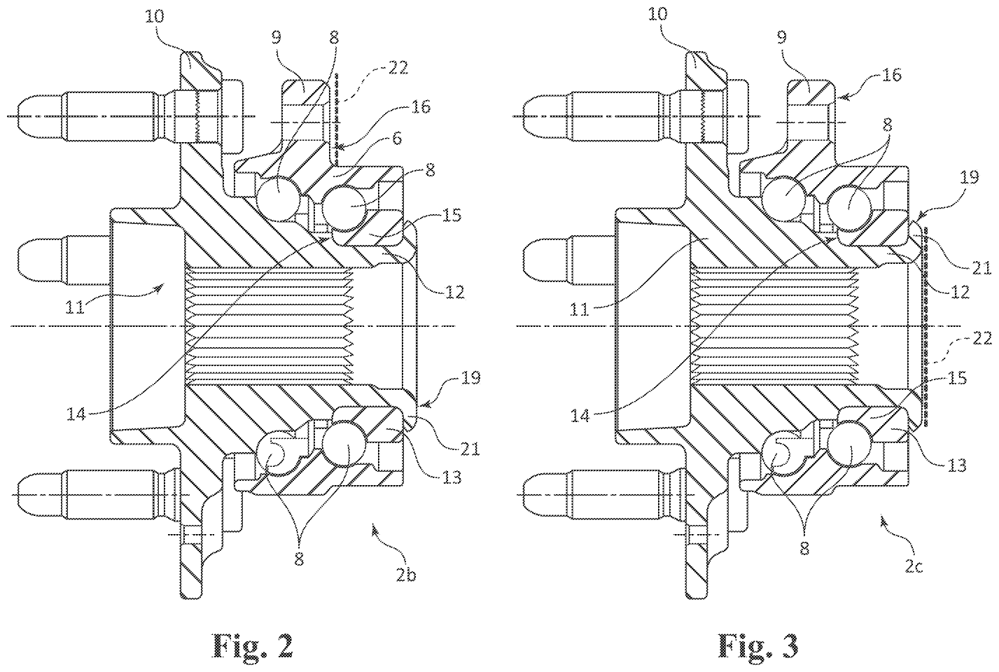

In some embodiments, metal surface 19 may be defined by a front face of small inner ring 13 on an axially opposite end of small inner ring 13 as front face 15 (see, e.g., FIG. 1). In other embodiments, metal surface 19 may be defined by an upset edge 21 of axial end 12 of inner ring 7. Upset edge 21 may be folded into an L-shape against an outer axial surface of small inner ring 13 to axially clamp small inner ring 13 to axial end 12 of inner ring 7 between axial shoulder 14 and upset edge 21 (see, e.g., FIGS. 2 and 3).

In some embodiments, a protective layer or coating 22 may be applied to and cover at least one of first and third metal surface 16, 19. In some embodiments, coating 22 may include a matrix 23 containing uniformly dispersed hard particles 24 with a Mohs hardness greater than a hardness of second or fourth metal surface 18, 20. In some embodiments, second and fourth metal surface 18, 20 may be made of untampered steel. In such embodiments, hard particles 24 may be regarded as “planted” in second and fourth metal surfaces 18, 20, acting as “nails” between coupled surfaces and advantageously preventing micro-slipping between second metal surface 18 and first metal surface 16 and between third metal surface 19 and fourth metal surface 20, even under high and localized external stresses.

As illustrated in FIG. 1, coating 22 may be applied to both first and third metal surfaces 16, 19.

In some embodiments, coating 22 may be applied to a surface 16 defined by an axial face of flange 9 facing away from flange 10 so as to cooperate, in contact, with suspension pillar 5 (see, e.g., FIG. 2) and couple outer ring 6 to suspension pillar 5. In some embodiments, suspension pillar 5 may be made of a sheared and folded sheet metal, for example steel, or aluminum or aluminum alloys, by casting and/or forging and subsequent machining. This coupling between first metal surface 16 of outer ring 6 and second metal surface 18 of suspension pillar 5 ensures a stable angular coupling of outer ring 6 with suspension pillar 5.

In some embodiments, an axial surface of folded edge 21 facing towards constant velocity joint 4 when in use may receive coating 22 (see, e.g., FIG. 3) and couple inner ring 7 to constant velocity joint 4. This coupling between folded edge 21 of inner ring 7 and constant velocity joint 4 ensures a stable angular coupling of inner ring 7 to constant velocity joint 4.

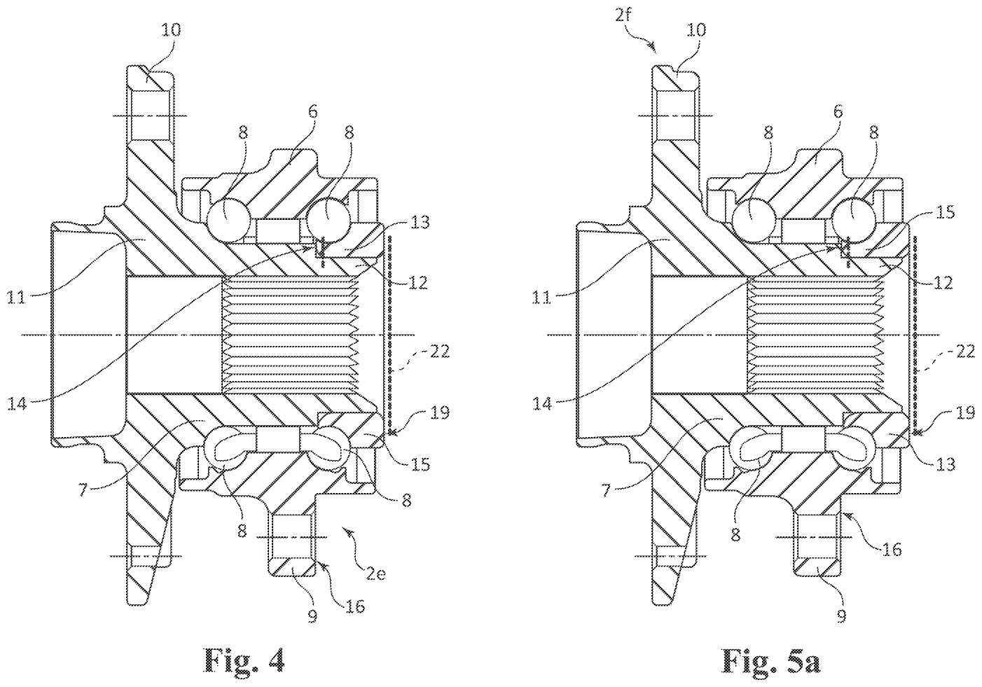

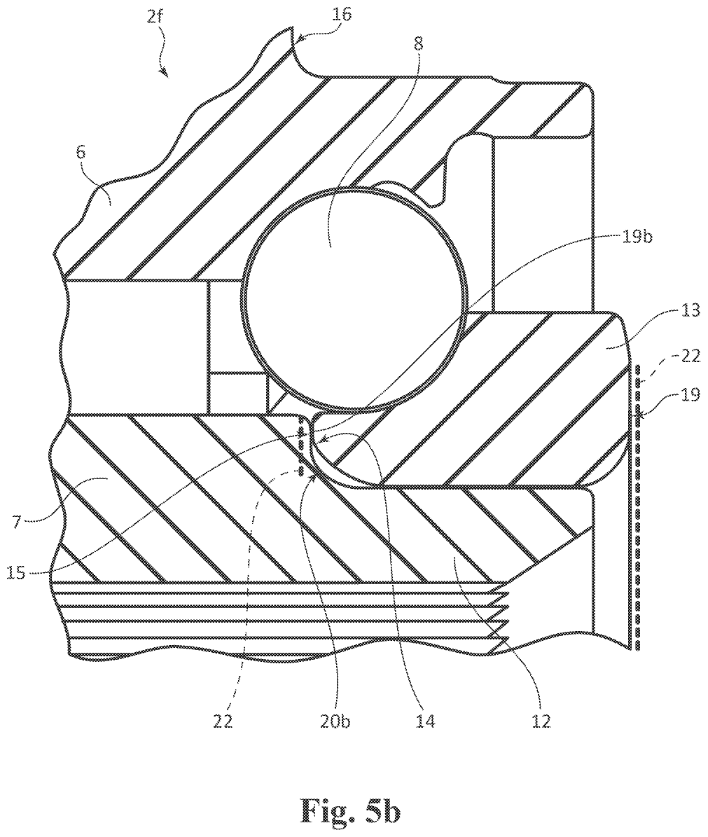

In some embodiments, small inner ring 13 may be locked against axial shoulder 14 directly by constant velocity joint 4, with no folded edge 21 made in axial end 12 of inner ring 7 (see, e.g., FIGS. 4 and 5). In such embodiments, coating 22 may be applied to a front face of small inner ring 13 facing constant velocity joint 4 opposite face 15. In some embodiments, the front face of small inner ring 13 may extend axially beyond axial end 12 and hang over an edge of axial end 12. This coupling between the front face of small inner ring 13 facing constant velocity joint 4 and constant velocity joint 4 ensures a stable angular coupling of small inner ring 13 to constant velocity joint 4.

In some embodiments, a matrix 23 that makes up coating 22 may be organic, e.g., made of a synthetic polymer or a mixture of synthetic polymers, or inorganic, e.g., metallic. In some embodiments, an inorganic matrix 23 may be made of a metal or metal alloy that has a lower electrode potential than steel such that matrix 23 may act as a sacrificial anode providing cathodic protection for first and third metal surface 16, 19 against corrosion caused by environmental contaminants.

In some embodiments, coating 22 may include one or more hard particles 24 that may be irregularly shaped abrasive particles with a Mohs hardness equal to or greater than 9. In some embodiments, hard particles 24 may further include sharp edges. By including hard particles 24 in coating 22, the amount of coating 22 present is reduced by the amount of hard particles 24 present therein, reducing overall costs of coating 22 and environmental detriment caused by use of coating 22.

In some embodiments, an organic matrix 23 may be made of polyurethane-based polymers, epoxy-based polymers, acrylic-based copolymers, or mixtures thereof. Such polymers may include an ultra-violet (UV) light-cured varnish or an infrared (IR) light-cured varnish.

Conversely, in some embodiments, an inorganic matrix 23 may be made of a metal or metal alloy and applied or plated on first and/or third metal surface 16, 19, in which hard particles 24 have been dispersed in matrix 23 prior to application of coating 22. In some embodiments, coating 22 may be platted onto metal surface by hot spraying.

In some embodiments, coating 22 may be applied to front face 15 of small inner ring 13 and/or to a surface 19b of axial shoulder 14. Surface 19b of axial shoulder 14 may contact a surface 20b of front face 15 of smaller inner ring 13. Matrix 23 of coating 22 applied to axial shoulder 14 and/or front face 15 may include an anaerobic sealant paste, in which hard particles 24 may be dispersed evenly prior to applying coating 22 to surfaces 19b and 20b of axial shoulder 14 and front face 15, respectively. In some embodiments, hard particles 24 may be planted in surface 20b, acting as anchoring elements between coupled surfaces 20b and 19b, thereby preventing micro-slipping between the two surfaces, even under high and localized external stresses. This coupling between surface 19b of axial shoulder 14 and surface 20b of front face 15 ensures a stable angular coupling of inner ring 7 to small inner ring 13.

In some embodiments, coating 22 may have a thickness of between 20 μm and 100 μm, and preferably between 30 μm and 60 μm.

In some embodiments, coating 22 may contain a quantity of hard particles 24 dispersed in an organic or metallic matrix 23 of between 10% and 50% by weight calculated using a total weight of coating 22. For example, this may include using the weight of coating 22 per unit area, and matrix 23 may contain a quantity of hard particles 24 of about 30% by weight.

In some embodiments, coating 22 may be a matrix 23 formed as a zinc layer having a thickness of 20 μm to 100 μm thick in which a quantity of hard particles 24 between 10% and 50% by weight using the total weight of coating 22 may be dispersed. These particular thickness values for coating 22 allow for hard particles 24 to also become planted in surfaces 16, 19, and 19b, which serves as an additional locking mechanism to secure corresponding surfaces together.

In some embodiments, hard particles 24 may be between 15 μm and 60 in size, and may be made of corundum, alumina, silicon carbide, or industrial diamond.

In some embodiments, hard particles 24 in an organic matrix 23 with a light-cured varnish may be made of silicon carbide, which is an opaque material. Because silicon carbide is opaque, it is advantageous to use with a light cured varnish, such as a UV light-cured varnish or a IR light-cured varnish, as an opaque material will have a reduced impact on absorption of UV or IR light when matrix 23 is cured as compared to materials with a more reflective surface. Alternatively, in some embodiments, hard particles 24 in an organic matrix 23 with a light-cured varnish may be made of diamond, corundum, or alumina. In some embodiments, a matrix 23 with a light-cured varnish having hard particles 24 in quantities described herein, e.g., 10%-50% of the total weight of coating 22, may have a curing time of about 10-12 seconds, thereby preventing dripping and enabling uniform dispersal of hard particles 24.

Advantageously, components coupled with coating 22, e.g., metal surfaces 16, 18, 19, 20, 19b, 20b, may be reused during maintenance of wheel hub unit 1, owing to the dimensions and distributions of hard particles 24 in matrix 23 of coating 22. In other words, the presence of hard particles 24 coating 22 improves the durability and therefore extends the working life of the components to which it is applied. Furthermore, because hard particles 24 may be made of materials such as corundum, alumina, and silicon carbide, they may be recovered from spend grinding wheels, for example by crushing and sieving spent grinding wheels with ball milling. Alternatively, hard particles 24 may be purchased as raw material.

By eliminating micro-slipping between surfaces during operation of wheel hub unit 2 and also acting as a protective coating against corrosion of outer ring 6 and inner ring 7, use of coating 22 reduces and/or eliminates noise resulting from steering and abrupt reversals of torque. This is particularly advantageous for electric vehicles, as such vehicles are generally quieter than non-electric vehicles.

In some embodiments, when coupling elements are locked together, e.g., when constant velocity joint 4 is coupled to wheel hub unit 2, a plurality of indentations may be formed on two corresponding coupling surfaces, e.g., first and second metal surfaces 16 and 18, third and fourth metal surfaces 19 and 20, and surfaces 19b and 20b. These indentations significantly increase a coefficient of friction between the two coupled surfaces that results in an even distribution of stresses over the coupled surfaces that reduces localized, high stress regions that cause stick-slip conditions leading to micro-slipping. In some embodiments, the plurality of indentations may be formed due to the high contact pressure between the coupled surfaces, the relatively high hardness of the surfaces compared to the hardness of constant velocity joint 4, and the relatively small dimensions of hard particles 24.

A person of ordinary skill in the art will appreciate that the teachings of the present disclosure may be applied to a wheel hub unit having similar components and characteristics of wheel hub unit 2 described herein, whether part of a wheel hub assembly, e.g., wheel hub assembly 1, or not.

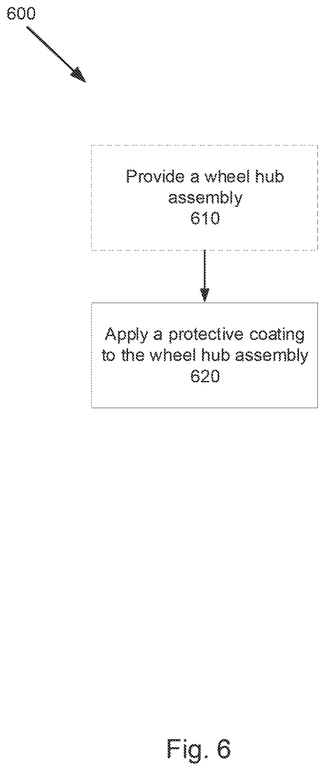

As illustrated in FIG. 6, a method 600 for reducing noise in a wheel hub assembly and for ensuring the stability of an angular coupling between two mechanical elements of the wheel hub assembly may include applying 620 a coating, e.g., coating 22 to a wheel hub assembly, e.g., wheel hub assembly 1. In some embodiments, coating 22 may be applied to at least one of opposing metal surfaces 16:18, 19:20, and 19b:20b, as well as to inner ring 7 and to constant velocity joint 4. In some embodiments, coating 22 may be applied to axial shoulder 14 of inner ring and to small inner ring 13. In some embodiments, coating 22 may be made of either an organic matrix 23, such as a synthetic polymer or mixture of synthetic polymers, or an inorganic matrix 23, such as a metal matrix, in which hard particles 24 may be dispersed. In some embodiments, the amount of hard particles 24 may constitute 10% and 50% of the total weight of coating 22, hard particles 24 may have a Mohs hardness of 9 or more, and hard particles 24 may have dimensions of between 15 μm and 60 μm. In some embodiments, hard particles 24 may be uniformly dispersed in matrix 23 (whether organic or inorganic), and coating 22 may have a thickness of between 20 μm and 100 μm.

As illustrated in FIG. 6, method 600 may optionally include step 610 of providing a wheel hub assembly prior to step 620 of applying a protective coating to the wheel hub assembly. In some embodiments, providing a wheel hub assembly may include providing wheel hub assembly 1.

Application of coating 22 need not be limited to the embodiments described herein, and may be utilized to improve mechanical couplings throughout wheel hub assembly 1. For example, a coating 22 may be applied directly to a surface of constant velocity joint 4 or other components of a vehicle transmission with similar torque conditions as a way to reduce noise generated thereby. In some embodiments, coating 22 may be applied to contact surfaces of elements a vehicle chassis and related fastening surfaces, such as nuts and screw heads.

Embodiments consistent with the present disclosure possess numerous benefits in addition to those already described, including but not limited to, a negligible axial footprint resulting in more available space to optimize bearing performance and wheel-end geometries, a simplified and low-cost solution that reduces risk of assembly and service errors given the fact that no additional components are required in the wheel hub assembly, and a reduction and/or elimination of creep under load with no risk of friction loss in bolts.

In addition to the exemplary embodiments of the disclosure described herein, it is to be understood that numerous other variants exist. It is also to be understood that such embodiments are exemplary only and limit neither the scope of the disclosure, its applications, nor its possible configurations. On the contrary, although the description herein allows a person of ordinary skill in the art to carry out the present disclosure, it may be understood that many variants of the components described are possible, without thereby departing from the scope of the disclosure, as defined in the attached claims, which are interpreted literally and/or according to their legal equivalents.

It should be noted that the use of particular terminology when describing certain features or embodiments of the disclosure should not be taken to imply that the terminology is being re-defined herein to be restricted to include any specific characteristics of the features or embodiments of the disclosure with which that terminology is associated. Terms and phrases used in this disclosure, and variations thereof, especially in the appended claims, unless otherwise expressly stated, should be construed as open-ended as opposed to limiting. As examples of the foregoing, the term “including” should be read to mean “including, without limitation,” “including but not limited to,” or the like; the term “comprising” as used herein is synonymous with “including,” “containing,” or “characterized by,” and is inclusive or open-ended and does not exclude additional, unrecited elements or method steps; the term “having” should be interpreted as “having at least”; the term “such as” should be interpreted as “such as, without limitation”; the term “includes” should be interpreted as “includes but is not limited to”; the term “example” is used to provide exemplary instances of the item in discussion, not an exhaustive or limiting list thereof, and should be interpreted as “example, but without limitation”; adjectives such as “known,” “normal,” “standard,” and terms of similar meaning should not be construed as limiting the item described to a given time period or to an item available as of a given time, but instead should be read to encompass known, normal, or standard technologies that may be available or known now or at any time in the future; and use of terms like “preferably,” “preferred,” “desired,” or “desirable,” and words of similar meaning should not be understood as implying that certain features are critical, essential, or even important to the structure or function of the present disclosure, but instead as merely intended to highlight alternative or additional features that may or may not be utilized in a particular embodiment.

Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should be read as “and/or” unless expressly stated otherwise. The terms “about” or “approximate” and the like are synonymous and are used to indicate that the value modified by the term has an understood range associated with it, where the range may be ±20%, ±15%, ±10%, +5%, or +1%. The term “substantially” is used to indicate that a result (e.g., measurement value) is close to a targeted value, where close may mean, for example, the result is within 80% of the value, within 90% of the value, within 95% of the value, or within 99% of the value. Also, as used herein “defined” or “determined” may include “predefined” or “predetermined” and/or otherwise determined values, conditions, thresholds, measurements, and the like.

We claim:

1. A wheel hub assembly, comprising:
a wheel hub unit comprising:
a radially outer ring comprising a first metal surface;
a radially inner ring comprising a third metal surface; and
a plurality of rolling bodies interposed between the inner ring and the outer ring;
a suspension pillar comprising a second metal surface butt coupled to the first metal surface of the radially outer ring;
a constant velocity joint comprising a fourth metal surface butt coupled to the third metal surface of the radially inner ring; and
a coating comprising:
a plurality of hard particles uniformly dispersed in the coating and comprising a Mohs hardness greater than a hardness of the second metal surface and greater than a hardness of the fourth metal surface; and
one of an organic matrix and an inorganic matrix,
wherein the coating covers at least one of the first metal surface and the third metal surface.

2. The wheel hub assembly of claim 1, wherein the hard particles comprise irregularly shaped abrasive particles with a Mohs hardness of at least 9.

3. The wheel hub assembly of claim 2, wherein the matrix further comprises one of a UV light-cured varnish and an IR light-cured varnish.

4. The wheel hub assembly of claim 2, wherein the matrix further comprises an anaerobic sealant paste, wherein the plurality of hard particles are dispersed prior to the coating being applied to at least one of the first metal surface and the third metal surface.

5. The wheel hub of claim 1, wherein the coating covers at least one of the second metal surface and the fourth metal surface.

6. The wheel hub assembly of claim 5, wherein
the coating comprises the organic matrix,
the coating comprises a thickness of between 20 μm and 100 μm,
the organic matrix comprises at least one of one or more polyurethane-based polymers, one or more epoxy-based polymers, and one or more acrylic-based copolymers, and
the hard particles comprise 10% and 50% of a total weight of the coating.

7. The wheel hub assembly of claim 1, wherein
the coating covering at least one of the first metal surface and the third metal surface comprises the inorganic matrix,
the inorganic matrix comprises one of a metal and a metal alloy, and
the hard particles are dispersed in the coating before the coating is applied to at least one of the first metal surface and third metal surface.

8. The wheel hub assembly of claim 6, wherein
the hard particles comprise dimensions between 15 μm and 60 μm, and
the hard particles comprise one of corundum, alumina, and silicon carbide.

9. The wheel hub assembly of claim 7, wherein
the matrix comprises a zinc layer comprising a thickness of between 20 μm to 100 μm, and
the hard particles comprise between 10% and 50% of a total weight of the coating.

10. The wheel hub assembly of claim 7, wherein
the hard particles comprise dimensions between 15 μm and 60 μm, and
the hard particles comprise one of corundum, alumina, and silicon carbide.

11. A wheel hub unit comprising:
a radially outer ring comprising a first metal surface configured to couple to a second metal surface of a suspension pillar;
a first radially inner ring comprising a first axial end comprising an axially facing front face and a second axial end comprising an axial shoulder;
a second inner ring butt coupled to the axial shoulder of the second axial end of the first inner ring; and
a plurality of rolling bodies interposed between the inner ring and the outer ring; and
a coating comprising:
a plurality of hard particles uniformly dispersed in the coating and comprising a Mohs hardness of at least 9, dimensions of between 15 μm and 60 μm, and between 10% and 50% of a total weight of the coating; and
one of an organic matrix and an inorganic matrix,
wherein at least one of the first axial end of the first inner ring and the second inner ring comprises a third metal surface configured to couple to a fourth surface of a constant velocity joint,
at least one of the first metal surface of the outer ring and the third metal surface of the inner ring are covered with the coating, and
the coating comprises a thickness of between 20 μm and 100 μm.

12. The wheel hub unit of claim 11, wherein
the coating covers the third metal surface, and
the coating comprises an anaerobic sealant paste.

13. The wheel hub unit of claim 11, wherein the hard particles comprise irregularly shaped abrasive particles.

14. The wheel hub unit of claim 11, wherein
the coating covering at least one of the first metal surface and the third metal surface comprises the inorganic matrix,
the inorganic matrix comprises one of a metal or a metal alloy, and
the hard particles are dispersed in the coating before the coating is applied to at least one of the first metal surface and the third metal surface.

15. The wheel hub unit of claim 15, wherein the matrix further comprises one of a UV light-cured varnish and an IR light-cured varnish.

16. The wheel hub unit of claim 11, wherein
the coating comprises the organic matrix,
the organic matrix comprises at least one of one or more polyurethane-based polymers, one or more epoxy-based polymers, and one or more acrylic-based copolymers.

17. A method comprising:
applying a coating to at least one of a first metal surface of an outer ring of a wheel hub unit configured to couple to a second metal surface of a suspension pillar and a third metal surface of an inner ring of the wheel hub unit configured to couple to a fourth metal surface of a constant velocity joint,
wherein the coating comprises:
a plurality of hard particles uniformly dispersed in the coating and comprising a Mohs hardness of at least 9, dimensions of between 15 μm and 60 μm, and between 10% and 50% of a total weight of the coating; and
one of an organic matrix and an inorganic matrix,
the coating comprising a thickness of between 20 μm and 100 μm.
